(19) United States
(12) Patent Application Publication
(10) Pub. No.: US 2017/0206872 A1
(43) Pub. Date: Jul. 20, 2017

(54) Systems and Methods of Illuminating Instrument Features

(71) Applicants: Mason Evans Murphy, Franklin, TN (US); Michael Willett, Dacula, GA (US)

(72) Inventors: Mason Evans Murphy, Franklin, TN (US); Michael Willett, Dacula, GA (US)

(21) Appl. No.: 15/411,903

(22) Filed: Jan. 20, 2017

Related U.S. Application Data
(60) Provisional application No. 62/280,704, filed on Jan. 20, 2016.

(51) Int. Cl. G10G 7/00; H04N 9/12; F21V 33/00

(52) U.S. Cl. CPC G10G 7/00; F21V 33/0056; H04N 9/12

(57) ABSTRACT

The systems and methods of illuminating instrument features disclosed herein provide for the illumination of the interior of an instrument, such as an acoustic guitar with a “sound hole”, and a drum, among others, with an illumination source (a non-limiting example is light emitting diodes (LEDs)). One or more illumination sources may be attached to the inside of the instrument to direct light such that the hole is illuminated. The illuminated opening may reveal as non-limiting examples, logos, art work, messages, wording, and text, among others.

### CROSS-REFERENCE TO RELATED APPLICATION

This application claims benefit to U.S. provisional patent application Ser. No. 62/280,704, filed on Jan. 20, 2016, which is incorporated by reference herein.

### TECHNICAL FIELD

The present disclosure is generally related to instruments and, more particularly, is related to illuminating instrument features.

### BACKGROUND

The center of many musical performances is the instrument used to play the music. Features of the instrument have been ignored for providing entertainment outside of the generation of music. There are heretofore unaddressed needs with provision of marketing and entertainment using constructive features of the instrument.

### SUMMARY

Example embodiments of the present disclosure provide systems of illuminating instrument features. Briefly described, in architecture, one example embodiment of the system, among others, can be implemented as follows: a musical instrument with a feature; and an illumination source for illuminating the feature.

Embodiments of the present disclosure can also be viewed as providing methods for illuminating instrument features. In this regard, one embodiment of such a method, among others, can be broadly summarized by the following steps: providing a musical instrument; and illuminating a feature of the musical instrument.

### BRIEF DESCRIPTION OF THE DRAWINGS

FIG. 1 is a diagram of an example embodiment of an instrument that may be illuminated.

FIG. 2 is a diagram of an example embodiment of a system of illuminating instrument features.

FIG. 3 is a diagram of an example embodiment of a control system of the system of illuminating instrument features of FIG. 2.

FIG. 4 is a diagram of an alternative example embodiment of the control system of FIG. 3.

FIG. 5 is a diagram of an alternative example embodiment of the system of illuminating instrument features of FIG. 2.

FIG. 6 is a flow diagram of an example embodiment of a method of illuminating instrument features.

### DETAILED DESCRIPTION

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

Although an acoustic guitar is used in all of the figures, any instrument feature may be illuminated using the systems and methods of illuminating instrument features disclosed herein. For example, the bell of a trumpet or a clarinet may be similarly illuminated.

An example embodiment of the systems and methods of illuminating instrument features disclosed herein provides for the illumination of the interior of an instrument, such as an acoustic guitar with a “sound hole”, and a drum, among others, with an illumination source (a non-limiting example is light emitting diodes (LEDs)). One or more illumination sources may be attached to the inside of the instrument to direct light such that the hole is illuminated. The illuminated opening may reveal as non-limiting examples, logos, art work, messages, wording, and text, among others.

The illumination source may be attached to a battery source that is attached to the guitar or the guitar strap. With this illumination, the eye is drawn toward the hole/opening in the acoustic guitar. The illumination source may be any solid color and may change color or pattern.

The illumination source may be activated by manual switch or by wireless remote control. Remote control may encompass, as non-limiting examples, Wi-Fi, Bluetooth, FCC part 15 (868 mhz-918 mhz) and infrared (IR). In an example embodiment, the illumination of the guitar is controlled via an software application on a mobile device, allowing the user or a remote user such as a lighting designer to activate the illumination at a show or an event. With this wireless configuration, an app may playback shows or select colors per lighting protocol DMX512 or other mainstream control protocols such as RS232-35 and Artnet, among others.

In an alternative embodiment, the illumination source may be attached to direct light out of the front of the “sound hole” as well. Light would then shoot toward the audience. With this a ray of light may emit from and be directed straight out of the hole. Single color or multiple color LEDs may be used as non-limiting examples.

In another example embodiment, a projector, such as a pico-projector may be attached inside the acoustic guitar to project an image or a video on the inside of the instrument, such that the image may be viewable to the audience (for example, through the “sound hole” of an acoustic guitar). The image or video may be visible on the inside of the instrument or it may be projected out from the instrument such that it is viewable by the audience. In one example embodiment, the video presented from the projector is a 3D or holographic image.

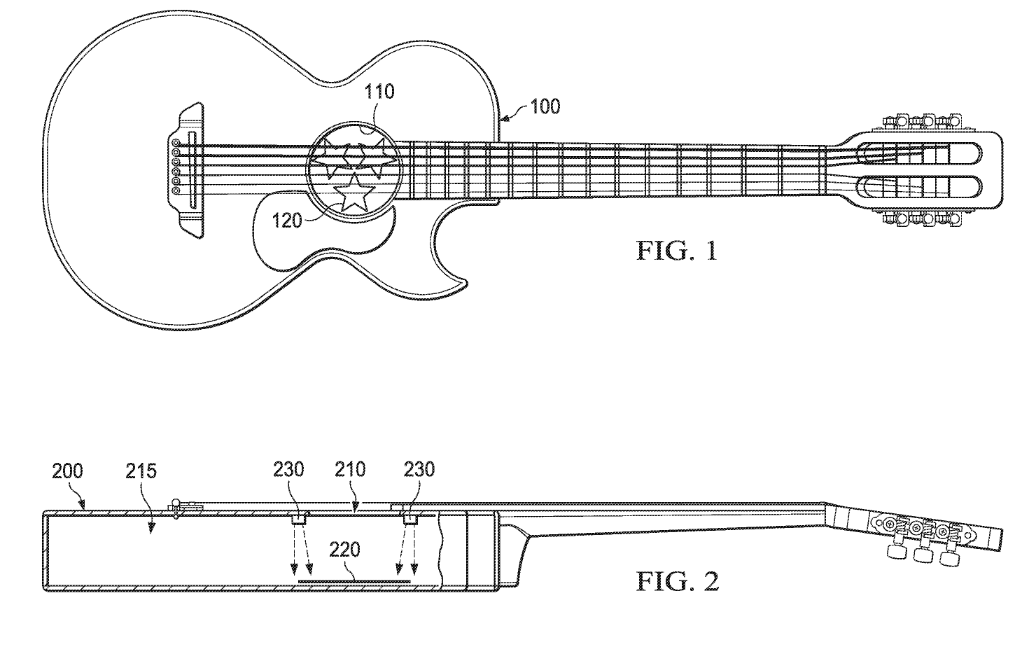

Turning now to the figures, FIG. 1 provides a diagram of an example embodiment of an instrument that may be illuminated, in this non-limiting case, acoustic guitar 100. Inside back surface 120 may be visible through opening 110.

FIG. 2 provides a diagram of an example embodiment of a system of illuminating instrument features in acoustic guitar 200. Inside back surface 220 may be visible through opening 210. One or more illumination sources 230 may be located in instrument interior 215. Various effects may be achieved by positioning one or more illumination sources 230 at various locations and at various angles within instrument interior 215 and on instrument 200. The one or more illumination sources 230 may illuminate inside back surface 220. Inside back surface 220 may have a label or some artistic or marketing information that may be visible to an audience, for example, when illuminated by the one or more illumination sources 230.

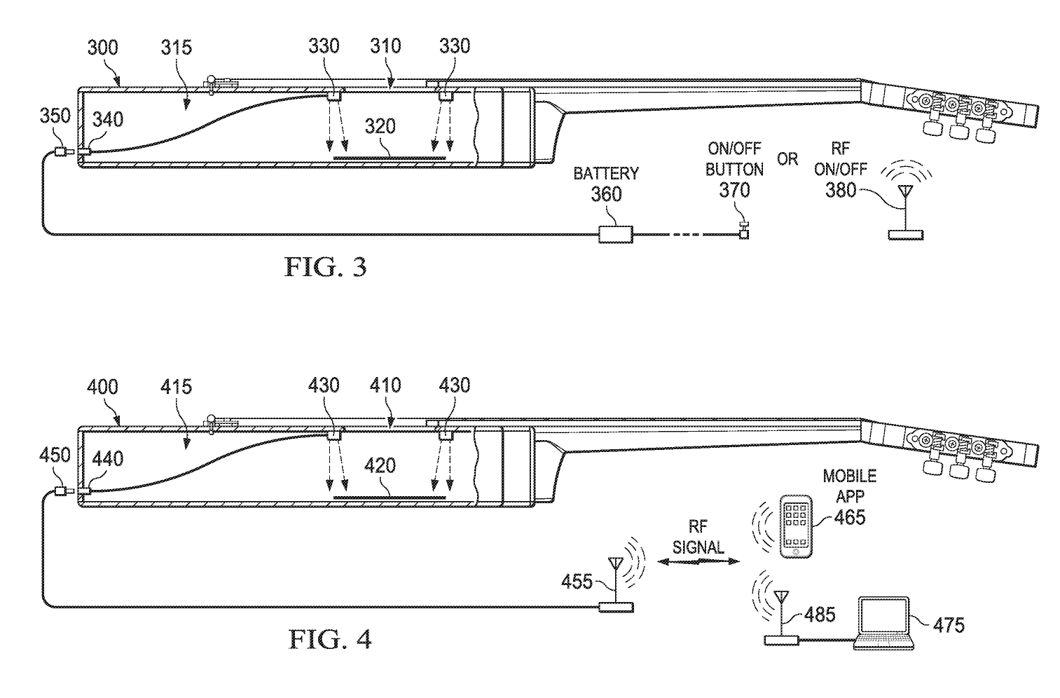

FIG. 3 is a diagram of an example embodiment of a control system of the system of illuminating instrument features of FIG. 2. Inside back surface 320 of acoustic guitar 300 may be visible through opening 310. One or more illumination sources 330 may be located in instrument interior 315. Various effects may be achieved by positioning one or more illumination sources 330 at various locations and at various angles within instrument interior 315 and on instrument 300. The one or more illumination sources 330 may illuminate inside back surface 320. Inside back surface 320 may have a label or some artistic or marketing information that may be visible to an audience, for example, when illuminated by the one or more illumination sources 330. One or more illumination sources 330 may be powered and/or controlled through a wire connected in instrument interior 315. Illumination sources 330 may be powered through an in-line battery 360 connected through connector 350 into plug 340. In an alternative embodiment, each illumination source 330 has its own power source, for example, a button battery. The power source for illumination sources 330 may be positioned outside instrument 300 or in instrument interior 315.

On/off switch 370 may be connected through plug 370 to control illumination sources 330. On/off switch 370 may be attached to a guitar strap, for example, or located on the instrument itself. In an alternative embodiment, control of illumination sources 330 may be provided by means of a radio frequency, infrared, Bluetooth, Near-field communication, or other wireless signal trough transmitter 380. Illumination sources 330 may be used to illuminate inside back surface 320; however, in an alternative embodiment, one or more illumination sources 330 may comprise a projector to project an image onto inside back surface 320 that may be viewable externally. In an example embodiment, video images and/or full motion video may be produced by one or more of a projector, LED panel, OLED panel, LCD panel, and the like. The source of the video images and/or full motion video may be stored locally in the instrument (as non limiting examples, in memory on a printed circuit board, a flash drive, an SD card, an XD card, and the like) or may be sent over a wired or wireless connection. In yet another alternative embodiment on or more illumination sources 330 may project a 3D image in instrument interior 315 that may be viewable externally.

FIG. 4 is a diagram of an alternative example embodiment of the control system of FIG. 3. Inside back surface 420 of acoustic guitar 400 may be visible through opening 410. One or more illumination sources 430 may be located in instrument interior 415. Various effects may be achieved by positioning one or more illumination sources 430 at various locations and at various angles within instrument interior 415 and on instrument 400. The one or more illumination sources 430 may illuminate inside back surface 420. Inside back surface 420 may have a label or some artistic or marketing information that may be visible to an audience, for example, when illuminated by the one or more illumination sources 430. One or more illumination sources 430 may be powered and/or controlled through a wire connected in instrument interior 415.

In an example embodiment, control of illumination sources 430 may be provided by means of a radio frequency, infrared, Bluetooth, Near-field communication, or other wireless signal trough transmitter 485 and received at receiver 455. Receiver 455 may be connected to illumination sources 430 through connector 450 into plug 440. Alternatively, control of illumination sources 430 may be directly connected without the need for connector 450 and plug 440. Receiver 455 may be connected externally to instrument 400 or it may be located in instrument interior 415. Receiver 455 may be located, for example, on a carrying strap, or, as another non-limiting example, attached to an external surface of instrument 400. In an example embodiment, transmitter 485 transmits a wireless control signal to receiver 455. Transmitter 485 may be connected to computing system 475 for running software for complex or non-complex control of illumination sources 430. Alternatively, the wireless control signal may be provided to receiver 455 by wireless device 465 (such as a wireless telephone as a non-limiting example) and the control of illumination sources 430 may be accomplished with a software application on the wireless device.

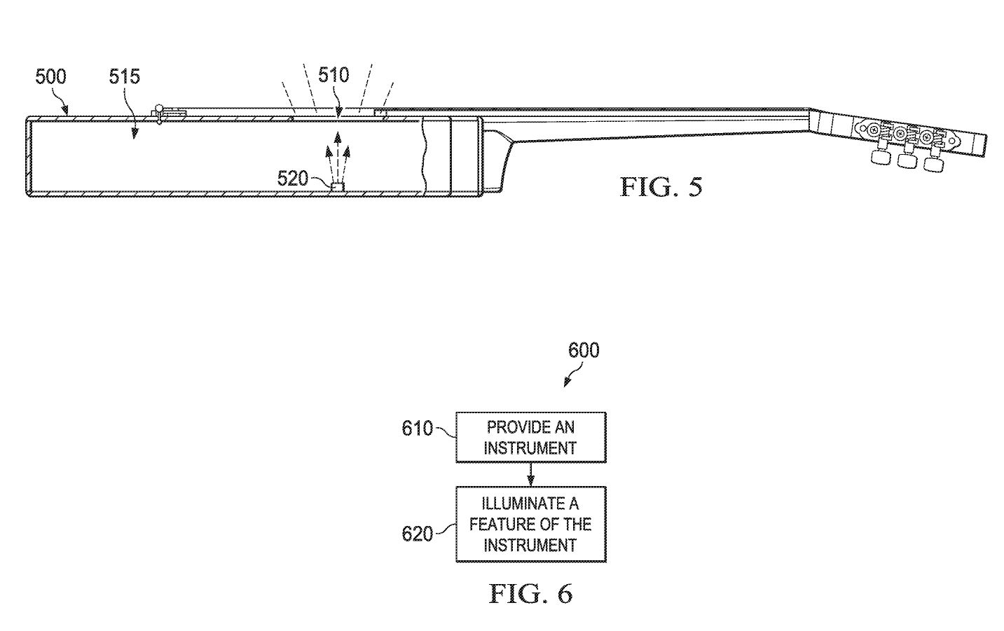

FIG. 5 is a diagram of an alternative example embodiment of the system of illuminating instrument features of FIG. 2. One or more illumination sources 520 may be positioned on the inside back surface of instrument 500. One or more illumination sources 520 may be visible through opening 510. One or more illumination sources 520 may be located at any location in instrument interior 515. Various effects may be achieved by positioning one or more illumination sources 520 at various locations and at various angles within instrument interior 515 and on instrument 500. The one or more illumination sources 520 may illuminate various surfaces of instrument 500. In an alternative embodiment, the instrument has at least part that is transparent and one or more illumination sources 520 cause an visual effect or are simply visible through the transparent part of instrument 500.

FIG. 6 is a flow diagram of an example embodiment of method of illuminating instrument features 600. In block 610 an instrument is provided. In block 620, a feature of the instrument is illuminated.

The flow chart of FIG. 6 shows the architecture, functionality, and operation of a possible implementation of the instrument illumination software. In this regard, each block represents a module, segment, or portion of code, which comprises one or more executable instructions for implementing the specified logical function(s). It should also be noted that in some alternative implementations, the functions noted in the blocks may occur out of the order noted in FIG. 6. For example, two blocks shown in succession in FIG. 6 may in fact be executed substantially concurrently or the blocks may sometimes be executed in the reverse order, depending upon the functionality involved. Any process descriptions or blocks in flow charts should be understood as representing modules, segments, or portions of code which include one or more executable instructions for implementing specific logical functions or steps in the process, and alternate implementations are included within the scope of the example embodiments in which functions may be executed out of order from that shown or discussed, including substantially concurrently or in reverse order, depending on the functionality involved. In addition, the process descriptions or blocks in flow charts should be understood as representing decisions made by a hardware structure such as a state machine.

The logic of the example embodiment(s) can be implemented in hardware, software, firmware, or a combination thereof. In example embodiments, the logic is implemented in software or firmware that is stored in a memory and that is executed by a suitable instruction execution system. If implemented in hardware, as in an alternative embodiment, the logic can be implemented with any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc. In addition, the scope of the present disclosure includes embodying the functionality of the example embodiments disclosed herein in logic embodied in hardware or software-configured mediums.

Software embodiments, which comprise an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, or communicate the program for use by or in connection with the instruction execution system, apparatus, or device. The computer readable medium can be, for example but not limited to, an electronic, magnetic, optical, electromagnetic, infrared, or semiconductor system, apparatus, or device. More specific examples (a nonexhaustive list) of the computer-readable medium would include the following: a portable computer diskette (magnetic), a random access memory (RAM) (electronic), a read-only memory (ROM) (electronic), an erasable programmable read-only memory (EPROM or Flash memory) (electronic), and a portable compact disc read-only memory (CDROM) (optical). In addition, the scope of the present disclosure includes embodying the functionality of the example embodiments of the present disclosure in logic embodied in hardware or software-configured mediums.

Although the present disclosure has been described in detail, it should be understood that various changes, substitutions and alterations can be made thereto without departing from the spirit and scope of the disclosure as defined by the appended claims.

Therefore, at least the following is claimed:

1. A system comprising:
a musical instrument with a feature; and
an illumination source for illuminating the feature.

2. The system of claim 1, wherein the musical instrument comprises an acoustic guitar.

3. The system of claim 1, wherein the illumination source comprises one or more light emitting diodes directed at an inside back surface of the musical instrument.

4. The system of claim 1, wherein the illumination source comprises a video source.

5. The system of claim 4, wherein the video source comprises at least one of a projector, LED panel, OLED panel, and LCD panel.

6. The device of claim 5, wherein the video source is supplied with data from at least one of a local source attached to the instrument or a wireless source.

7. A method, comprising:
providing a musical instrument; and
illuminating a feature of the musical instrument.

8. A non-transitory computer readable medium, comprising software with instructions for:
receiving data to be projected in a feature of a musical instrument;
projecting one or more images from the data in the feature of the musical instrument.
